(19) United States
(12) Patent Application Publication
(10) Pub. No.: US 2012/0037552 A1
(43) Pub. Date: Feb. 16, 2012

(54) DRAIN

(76) Inventors: Per Persson, Horby (SE); Per Thorsson, Lovestad (SE)

(21) Appl. No.: 12/672,120

(22) PCT Filed: Aug. 6, 2008
(86) PCT No.: PCT/SE08/50906

§ 371 Date: Sep. 30, 2011

(30) Foreign Application Priority Data
Aug. 8, 2007 (SE) 0701839-3

(51) Int. Cl. E03F 5/14; F16L 23/16

(52) U.S. Cl. 210/163; 285/363

(57) ABSTRACT

The present invention relates to a drain for fitting in the floor of a wet space or the like. The drain comprises a drain element (1) with an outlet (2) for leading liquid from the floor of the wet space to a drain system, and a fitting flange (3) disposed round, and running substantially horizontally from, the drain element. With the object of providing a drain which can be fitted both adjacent to one or more walls and at a distance from the walls of a wet space while maintaining optimum sealing properties relative to the wall or walls, where so required, and, of course, relative to the floor, the drain comprises in addition a sealing flange (7) so disposed that it runs substantially vertically from the horizontal fitting flange (3) along at least part of the periphery of the drain element (1) and at a distance from the drain element, to allow the drain to be fitted in the floor adjacent to one or more of the walls of the wet space, with the sealing flange against said wall or walls, and the sealing flange is so disposed as to be removable with the help of a cutting indication, to allow the drain to be fitted in the floor at a distance from the walls of the wet space.

### BACKGROUND TO THE INVENTION

The present invention relates to a drain for fitting in the floor of a wet space or the like, which drain comprises a drain element with an outlet for leading liquid from the floor of the wet space to a drain system, and a fitting flange disposed round, and running substantially horizontally from, the drain element.

Drains currently exist in many different configurations and versions. Some drains are intended to be placed in the floor of, for example, a wet space in such a way that the drain is situated far from the walls of the wet space. Other drains are configured to be fittable close to one or more walls. There are at present, however, no drains so configured as to allow them to be fitted both adjacent to one or more walls and at a distance from the walls without jeopardizing the sealing properties of the drain.

### BRIEF SUMMARY OF THE INVENTION

The object of the present invention is therefore to provide a drain which can be fitted both adjacent to at least one wall and at a distance from the walls of a wet space while maintaining optimum sealing properties relative to the wall, where so required, and, of course, relative to the floor.

To this end, the drain defined above according to the invention is characterized by comprising in addition a sealing flange which is so disposed that it runs substantially vertically from the horizontal fitting flange along at least part of the periphery of the drain element and at a distance from the drain element, to allow the drain to be fitted in the floor adjacent to at least one of the walls of the wet space, with the sealing flange against said wall, and by the sealing flange being so disposed as to be removable with the help of a cutting indication, to allow the drain to be fitted in the floor at a distance from the walls of the wet space.

The fact that the sealing flange can be removed according to need means that the drain, from being configured for fitting adjacent to at least one wall, can be modified for fitting at a distance from that and other walls.

Other objects and advantages of the invention will be apparent to one skilled in the art who studies the attached drawings and the detailed description set out below of preferred embodiments.

### BRIEF DESCRIPTION OF THE DRAWINGS

FIG. 1 depicts in a perspective view a first version of the drain according to the present invention.

FIG. 2 depicts the drain in a perspective view corresponding to FIG. 1 after it has been modified for fitting adjacent to a wall of, for example, a wet space.

FIG. 3 depicts the drain in a perspective view corresponding to FIG. 1 after it has been modified for fitting at a distance from the walls of, for example, a wet space.

FIG. 4 depicts the drain in a perspective view corresponding to FIG. 2 after it has been provided with a strainer frame and a strainer.

FIG. 5 depicts the drain in a perspective view corresponding to FIG. 3 after it has been provided with a strainer frame and a strainer.

FIG. 6 is a cross-section through the drain according to FIG. 1, with part of it enlarged.

FIG. 7 depicts in a perspective view a second version of the drain according to the present invention before it is fitted.

FIG. 8 depicts the drain in a perspective view corresponding to FIG. 7 after it has been adapted for fitting adjacent to a wall of, for example, a wet space.

FIG. 9 depicts the drain in a perspective view corresponding to FIG. 7 after it has been adapted for fitting adjacent to two walls of, for example, a wet space.

FIG. 10 depicts the drain in a perspective view corresponding to FIG. 7 after it has been adapted for fitting at a distance from the walls of, for example, a wet space.

### DETAILED DESCRIPTION OF PREFERRED EMBODIMENTS OF THE INVENTION

Each of the drains illustrated in the drawings is intended for fitting in the floor of a wet space or the like in a building. Said fitting may be effected adjacent to one or more walls of the wet space, where so desired, or at a distance from every wall of the wet space, where the need for this occurs. Fitting in the floor is effected in a conventional manner.

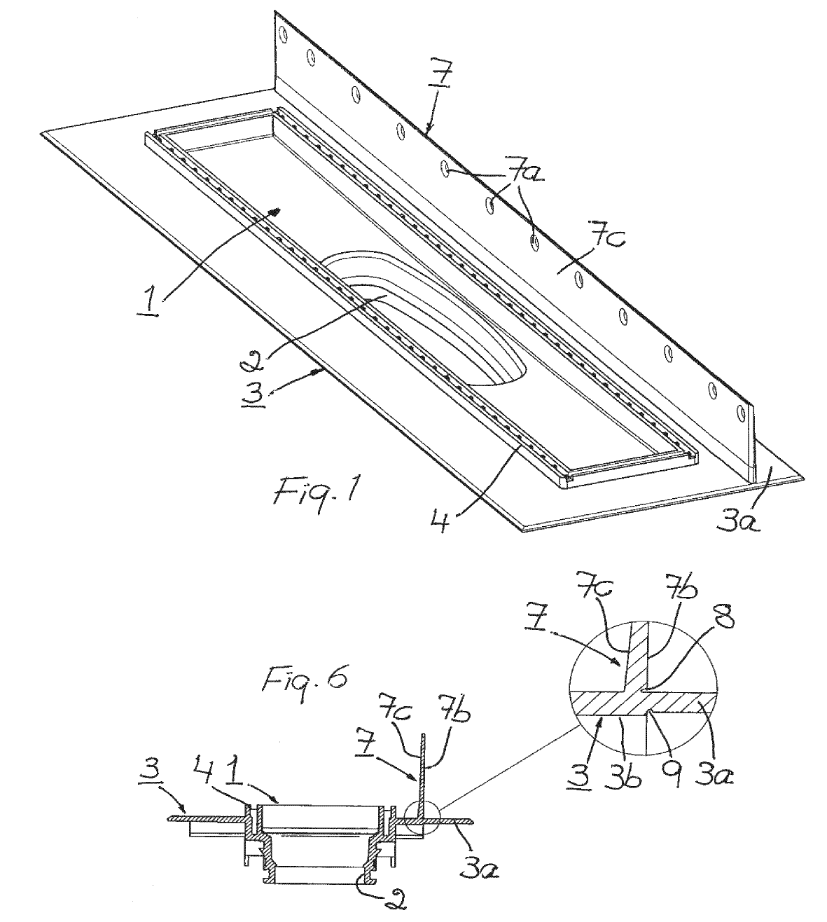

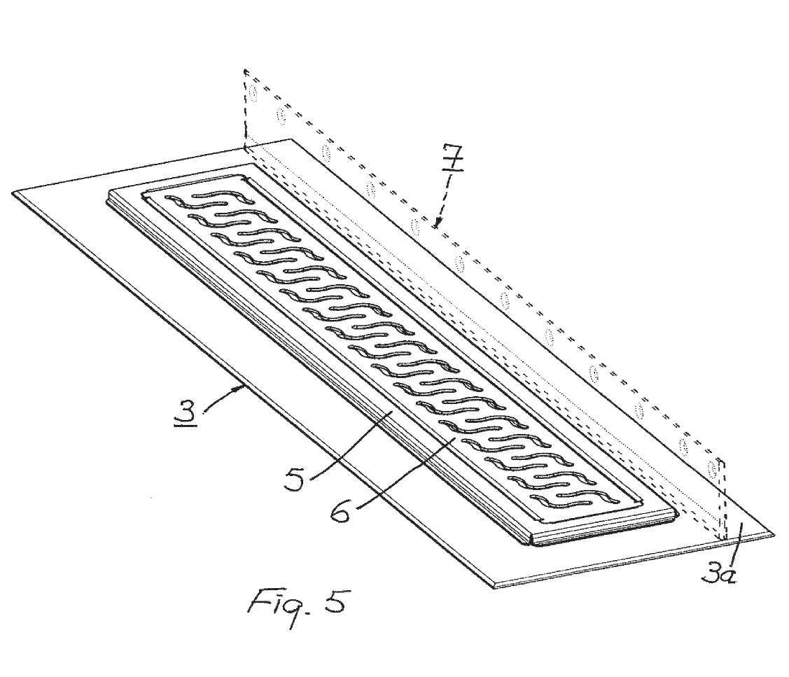

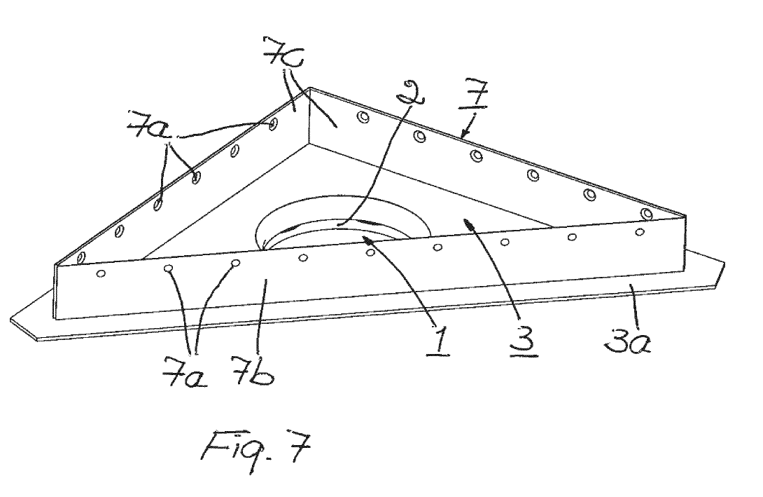

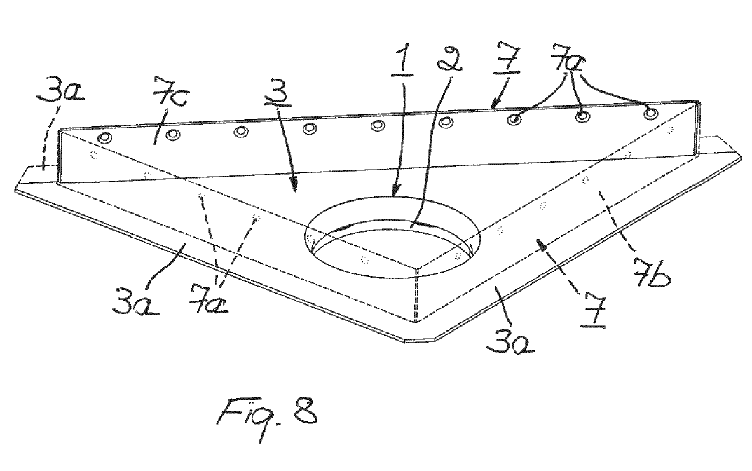

The drain comprises a drain element 1 with an outlet 2 for leading liquid from the floor of the wet space to an existing drain system in the building in which the wet space is situated. The drain element 1 may, as in the version according to FIGS. 1-6, be quadrilateral and rectangular, like a channel, but may alternatively also be square or have three, five or more sides and may of course also have a shape similar to a conventional circular floor drain, as in FIGS. 7-10, or be oval in shape. In short, it may be of any suitable shape. The channel-like drain element 1 according to FIGS. 1-6 slopes towards the outlet 2 in a suitable manner. A water trap, an odour barrier or the like may be applied at the connection to the outlet 2.

The drain comprises in addition a fitting flange 3 disposed round the drain element 1 and running substantially horizontally from the drain element. The fitting flange 3 may, for example, run substantially horizontally from substantially the upper edge of the drain element 1. The fitting flange 3 is intended to allow the drain to be fitted in the floor in such a way as to seal against the floorcovering material. When fitting the drain, the floorcovering material is applied in such a way that it runs over the fitting flange 3 to a holder 4 for a strainer frame 5 which surrounds the drain element 1 and is intended to accommodate a strainer 6 which, after the fitting of the drain, is placed over the drain element so as to rest on the strainer frame, which itself rests on the holder. The floorcovering material will thus preferably be level with the holder 4 and the strainer frame 5 with the strainer 6. Alternatively, the holder 4 may be dispensed with (see FIGS. 7-10) and the strainer (not depicted) may, for example, be clamped firmly in the drain element 1.

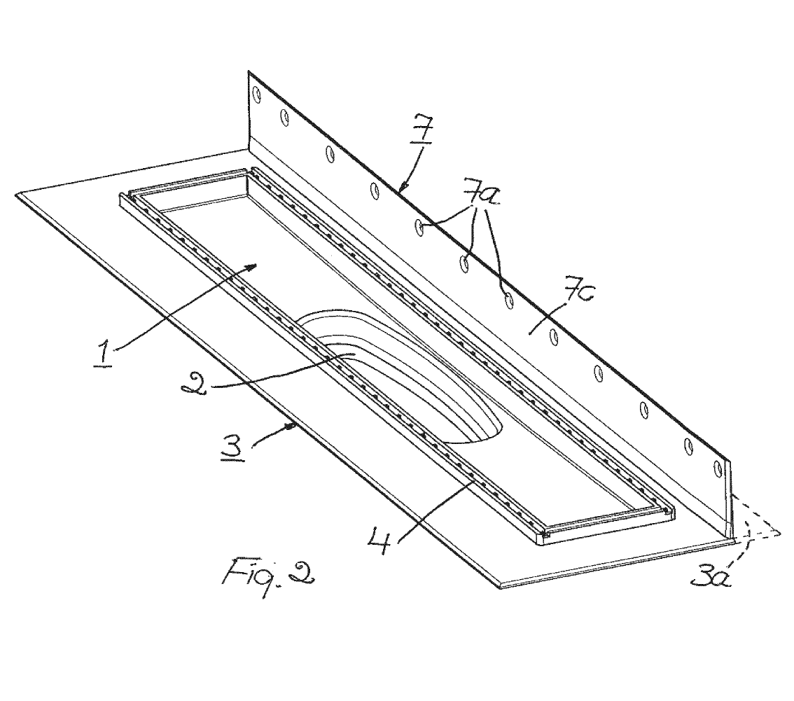

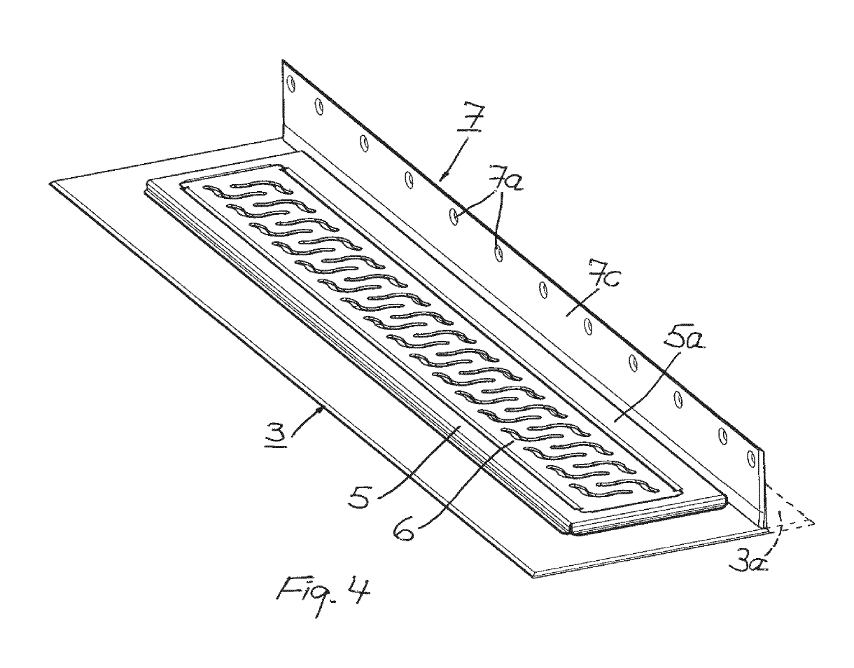

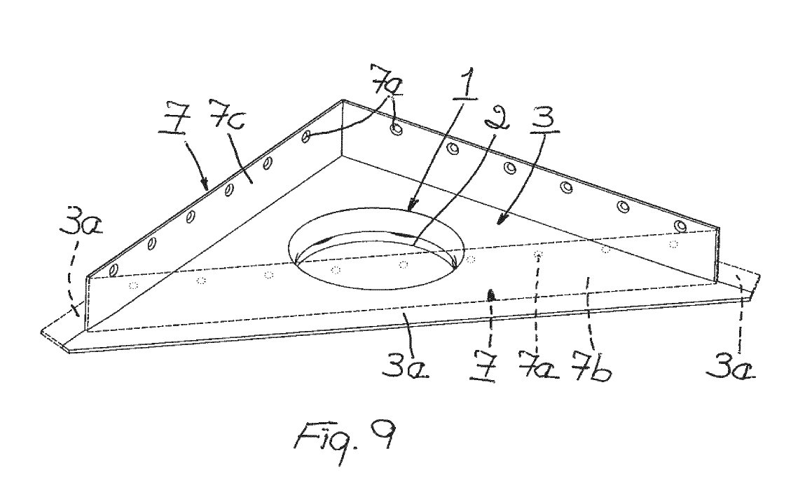

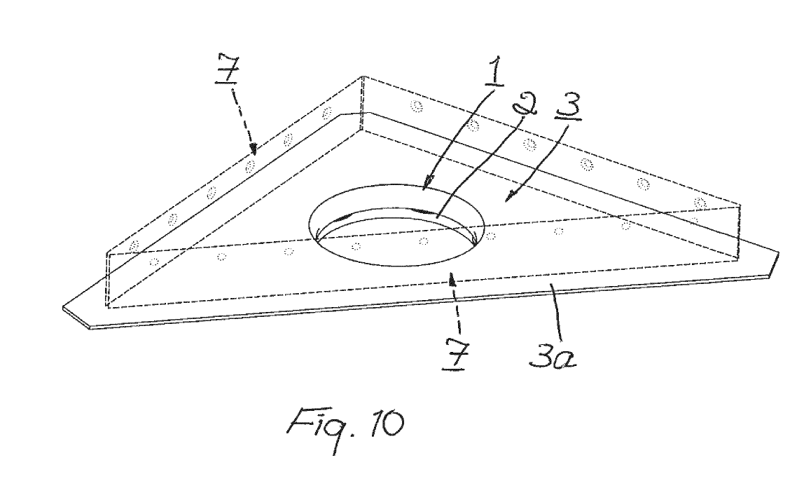

The drain according to the invention comprises in addition a sealing flange 7 which, when the drain is fitted in the floor of the wet space, is so disposed that it runs substantially vertically from the horizontal fitting flange 3 along at least part, but not the whole, of the periphery of the drain element 1. The sealing flange 7 is disposed at a distance from the drain element 1. The sealing flange 7 is used for fitting the drain in the floor of the wet space adjacent to one or more, in the versions according to FIGS. 2, 4 and 8 adjacent to one, of the walls of the wet space, and in the version according to FIG. 9 adjacent to two of the walls. The sealing flange 7 is thus placed in such a way as to seal against said wall or walls so that the wall cladding material runs over the sealing flange down to the fitting flange 3. The sealing flange 7 is fastened to the wall or walls by suitable fastening means such as screws (not depicted) and is preferably provided for the purpose with suitable screwholes 7a. In the case of fitting adjacent to one or more walls, it is advantageous to use a strainer frame 5 which is wider on the side 5a which faces towards the wall or walls and is here so configured as to bridge the distance between the drain element 1 and the sealing flange 7 (see FIG. 4). The advantage of this is that the floorcovering material need not run over the fitting flange 3 at this part of the fitting flange.

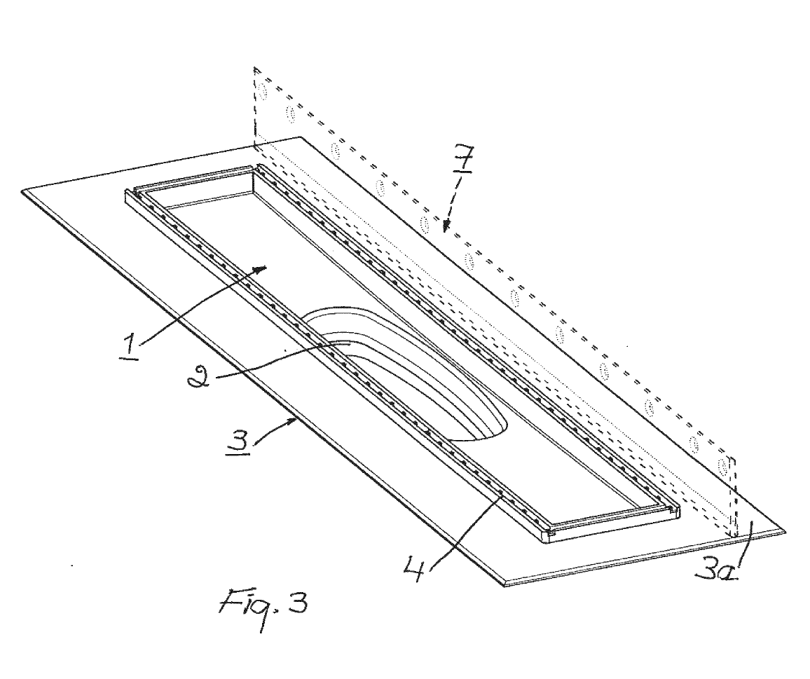

According to the invention, the sealing flange 7 is removable (see FIG. 3) to make it possible, where so desired, to fit the drain in the floor at a distance from the walls of the wet space, i.e. so that the drain element 1 will be at a considerably greater distance from the walls than in cases where the drain is fitted adjacent to one or more walls via the sealing flange.

The drain according to the invention is therefore universally usable for fitting wherever desired on the floor of the wet space.

Initially, before the drain is fitted in the floor of the wet space, the sealing flange 7 may be disposed in such a way as to run along the whole (see FIG. 7) or the major portion of the periphery of the drain element 1. Depending on how fitting is to be effected, one or more chosen portions of the sealing flange 7 may then be removed to allow the drain to be fitted in the floor adjacent to one or more of the walls of the wet space, with the remainder of the fitting flange against said wall or walls (see FIGS. 8 and 9), or the sealing flange may be removed completely to allow the drain to be fitted in the floor at a distance from the walls of the wet space (see FIG. 10).

Depending on the application, the fitting flange 3 may, like the drain element 1, be of any desired shape. The fitting flange 3 may therefore, as in the version according to FIGS. 1-6, be quadrilateral and rectangular but may also be square or have three (see FIGS. 7-10), five or more sides and may of course also be circular or oval.

Depending on the application, the sealing flange 7 may also, like the drain element 1 and the fitting flange 3, be of any desired shape. The sealing flange 7 may, in other words, be of any desired initial shape and may, in cases where the drain is fitted in the floor adjacent to one or more of the walls of the wet space, run along one, two, three or all except one of the sides of the drain element 1 or run in a circular or elliptical manner to the extent of substantially about 270° round the drain element.

The sealing flange 7 may with advantage have a length corresponding to the length of the fitting flange 3 on the side or sides of the drain element 1 along which the sealing flange runs. This applies particularly if the sealing flange 7 is on only one side of the drain element 1, as in the versions depicted, or if the sealing flange is on one or more sides thereof and at the outer edge of the fitting flange 3. Alternatively, the sealing flange 7 may in all cases have a length which is at least greater than the length of the side or sides of the drain element 1 along which it runs. This applies in particular if the sealing flange is on two or more sides of the drain element and at a distance from the outer edge of the fitting flange 3.

The sealing flange 7 may specifically, as in the versions of the drain depicted in the drawings, be also disposed at a distance from the outer edge of the fitting flange 3. In such cases, the sealing flange 7 may, as in the drawings, be situated somewhat closer to the drain element 1 than the outer edge of the fitting flange 3 (see preferably FIG. 6) or halfway between the drain element and the outer edge of the fitting flange or, as a further alternative, closer to the outer edge of the fitting flange than the drain element. The portion 3a of the fitting flange 3 which then is or remains between the sealing flange 7 and up to the outer edge of the fitting flange is, according to the invention, removable (see FIGS. 2, 8 and 9) to allow the drain to be fitted in the floor of the wet space adjacent to one or more of the walls of the wet space. The sealing flange 7 will thus be situated, precisely as when the sealing flange has been applied at the outer edge of the fitting flange 3, against said wall or walls of the wet space.

Cutting indications are provided to facilitate the removal of the sealing flange 7 and/or the respective portion 3a of the fitting flange 3. Thus the sealing flange 7 has for this purpose a cutting indication 8 at the bottom of its side 7b which faces towards the outer edge of the fitting flange 3, at the actual connection to the fitting flange. Similarly, the fitting flange 3 has a cutting indication 9 for its said portion 3a on the underside 3b of the fitting flange close to the sealing flange 7. The cutting indication 9 for said portion 3a of the fitting flange 3 is preferably situated opposite to the cutting indication 8 for the sealing flange 7 (see FIG. 6).

Removing the sealing flange 7 involves using, for example, a knife to make 2-4 cuts at the cutting indication 8 and 1-2 cuts on the side 7c of the sealing flange which faces towards the drain element 1, after which the sealing flange can be broken off and any remnants of it on the fitting flange 3 can be trimmed away. Removing the portion 3a of the fitting flange 3 involves using, for example, a knife to make 2-4 cuts at the cutting indication 9 and 1-2 cuts at the cutting indication 8, after which the portion 3a can be broken off and any remnants of it can be trimmed away.

All parts of the drain according to the invention are preferably made of one and the same plastic material, but they may also be made of more than one plastic material or even of some other material than plastic.

Apart preferably from the strainer frame 5 and the strainer 6, all parts of the drain according to the invention, i.e. the drain element 1 with the outlet 2 and, where applicable, with the holder 4 for the strainer frame, the fitting flange 3 and the sealing flange 7, may also be configured integrally. Alternatively, the drain, with the exception of the strainer frame 5 and the strainer 6, may be made in modular form. When the modules for the drain have been made, they will be joined together in a suitable manner to form a compact configuration. Each module may be so configured that it comprises a portion of the drain element 1, with the outlet 2 and, where applicable, with a portion of the holder 4 or, where applicable, with only a portion of the holder, a portion of the fitting flange 3 and a portion of the sealing flange 7. The portions of the respective modules of all of said items forming part of the drain are preferably configured integrally. If the drain is made up of modules, it comprises preferably a central module with the outlet 2, and two end modules or side modules. Whereas the central module will always be of the same length/size, the end modules or side modules may be of different lengths/sizes. The end modules and side modules respectively may also differ from one another in length/size. Thus drains of varying lengths/sizes may be configured as necessary and desired.

It will be obvious to one skilled in the art that in addition to what is indicated above the drain according to the present invention can be modified and altered within the scope of the claims set out below without departing from the idea and objects of the invention. Thus different configurations of drain elements 1, fitting flanges 3 and sealing flanges 7 may be combined with one another. A circular drain element 1 may, for example, be provided with a quadrilateral or square fitting flange 3 and a sealing flange 7 which has one, two or three sides. Conversely, it is conceivable to use for certain applications a quadrilateral drain element 1 provided with a circular fitting flange 3 and a sealing flange 7 which is circular or has one, two or three sides. Many combinations are possible.

1. A drain for fitting in the floor of a wet space or the like, the drain comprising:
a drain element (1) with an outlet (2) for leading liquid from the floor of the wet space to a drain system, and
a fitting flange (3) disposed round, and running substantially horizontally from, the drain element (1),
wherein the drain comprises in addition a sealing flange (7) which runs substantially vertically from the horizontal fitting flange (3) along at least part of the periphery of the drain element (1) and at a distance from the drain element, to allow the drain to be fitted in the floor adjacent to one or more of the walls of the wet space with the sealing flange against said wall or walls, and
the sealing flange (7) is removable with the help of a cutting indication (8) to allow the drain to be fitted in the floor at a distance from the walls of the wet space.

2. A drain according to claim 1,
wherein the sealing flange (7), before the drain is fitted in the floor of the wet space, is disposed in such a way that it runs along the whole or large parts of the periphery of the drain element (1), and
the sealing flange (7) is so disposed as to be both partly removable to allow the drain to be fitted in the floor of the wet space adjacent to one or more of the walls of the wet space, with the remainder of the sealing flange against said wall or walls, and be fully removable to allow the drain to be fitted in the floor at a distance from the walls of the wet space.

3. A drain according to claim 1, wherein,
the sealing flange (7) is also disposed at a distance from the outer edge of the fitting flange (3), and
the portion (3a) of the fitting flange (3) between the sealing flange (7) and up to the outer edge of the fitting flange is so disposed as to be removable to allow the drain to be fitted in the floor adjacent to one or more of the walls of the wet space, with the sealing flange against said wall or walls.

4. A drain according to claim 3, wherein the sealing flange (7) is disposed on the fitting flange (3) substantially halfway between the drain element (1) and the outer edge of the fitting flange.

5. A drain according to claim 1, wherein the drain element (1) has at least three sides.

6. A drain according to claim 1, wherein the drain element (1) has four sides.

7. A drain according to claim 6, wherein the drain element (1) is channel-like.

8. A drain according to claim 1, wherein the drain element (1) is circular or oval in shape.

9. A drain according to claim 1, wherein the drain element (1) is surrounded by a horizontal fitting flange (3) which has at least three sides.

10. A drain according to claim 1, wherein the drain element (1) is surrounded by a quadrilateral horizontal fitting flange (3).

11. A drain according to claim 1, wherein the drain element (1) is surrounded by a circular or oval horizontal fitting flange (3).

12. A drain according to claim 1, wherein the sealing flange (7) runs along one, two, three or all except one of the sides of the drain element (1), to allow the drain to be fitted in the floor adjacent to one or more of the walls of the wet space.

13. A drain according to claim 12, wherein the sealing flange (7) has a length which is at least greater than the length of the side or sides of the drain element (1) along which the sealing flange runs.

14. A drain according to claim 12, wherein the sealing flange (7) has a length which corresponds to the length of the fitting flange (3) on the side or sides of the drain element (1) along which the sealing flange runs.

15. A drain according to claim 1, wherein the sealing flange (7) runs to the extent of substantially about 270° round the drain element (1).

16. A drain according to claim 1, wherein the sealing flange (7) has a cutting indication (8) at the bottom of its side (7b) which faces towards the outer edge of the fitting flange (3).

17. A drain according to claim 3, wherein the fitting flange (3) has a cutting indication (9) for its said portion (3a) on the underside (3b) of the fitting flange close to the sealing flange (7).

18. A drain according to claim 17, wherein the cutting indication (9) for said portion (3a) of the fitting flange (3) is disposed opposite to the cutting indication (8) for the sealing flange (7).

19. A drain according to claim 1, wherein the drain comprises in addition a strainer (6) disposed over the drain element (1), and a strainer frame (5) for fitting the strainer, wherein the case of the drain being fitted adjacent to one or more walls the side (5a) of the strainer frame (5) which faces towards the wall or walls is configured to bridge the distance between the drain element (1) and the sealing flange (7).

20. A drain according to claim 1, wherein all parts of the drain, i.e. the drain element (1) with the outlet (2) and, where applicable, with a holder (4) for a strainer frame for fitting a strainer, the fitting flange (3), the strainer frame (5), the strainer (6) and the sealing flange (7), are made of at least one plastic material.

21. A drain according to claim 1, wherein the drain element (1) with the outlet (2) and, where applicable, with a holder (4) for a strainer frame for fitting a strainer, the fitting flange (3) and the sealing flange (7), are configured integrally.

22. A drain according to claim 1, wherein the drain comprises various modules which are joined together to form a compact configuration.

23. A drain according to claim 22, wherein the drain comprises a central module with the outlet, and two end modules or side modules.

24. A drain according to claim 22, wherein each module comprises a portion of the drain element (1), with the outlet (2) and, where applicable, with a portion of a holder (4) for a strainer frame (5) or, where applicable, with only a portion of the holder, a portion of the fitting flange (3) and a portion of the sealing flange (7).

25. A drain according to claim 24, wherein the portions in each module of said parts (1, 3, 7) of the drain are configured integrally.
